(19) United States
(12) Patent Application Publication
(10) Pub. No.: US 2026/0048935 A1
(43) Pub. Date: Feb. 19, 2026

(54) REFUSE COLLECTION VEHICLE GRABBER

(71) Applicant: The Heil Co., Chattanooga, TN (US)

(72) Inventors: Garrett J. Eckerl, Fort Payne, AL (US); Phillip A. Kendrick, Chattanooga, TN (US)

(21) Appl. No.: 19/300,394

(22) Filed: Aug. 14, 2025

Related U.S. Application Data
(60) Provisional application No. 63/683,434, filed on Aug. 15, 2024.

(51) Int. Cl. B65F 3/04; B25J 15/12; B65F 3/02

(52) U.S. Cl. CPC B65F 3/04; B25J 15/12; B65F 2003/0269

(57) ABSTRACT

A refuse collection vehicle includes a wheeled chassis, a lift arm, and a grabber. The lift arm is coupled to the wheeled chassis and operable to lift a refuse container. The grabber is coupled to a distal end of the lift arm and operable to grab the refuse container. The grabber includes a first arm that has non-uniform physical properties that vary along its length such that the first arm has a stiffness that varies along its length. A first section of the first arm has a lower stiffness than other sections of the first arm. The second arm faces and cooperates with the first arm to clamp and engage the refuse container.

### CROSS-REFERENCE TO RELATED APPLICATIONS

This application claims the benefit of U.S. Provisional Application No. 63/683,434, filed Aug. 15, 2024.

The disclosure of the prior application is considered part of (and is incorporated by reference in) the disclosure of this application.

### TECHNICAL FIELD

This disclosure relates to refuse collection vehicles.

### BACKGROUND

Refuse collection vehicles collect and transport solid waste. Some refuse collection vehicles use automated systems, such as robotic lift arms, to grab and lift garbage containers. Side loaders use laterally-extending lift arms with grabbers that clamp garbage containers to engage and lift the containers. Methods and equipment for improving refuse collection vehicles are sought.

### SUMMARY

Implementations of the present disclosure include a refuse collection vehicle that includes a wheeled chassis, a lift arm, and a grabber. The lift arm is coupled to the wheeled chassis and operable to lift a refuse container. The grabber is coupled to a distal end of the lift arm and operable to grab the refuse container. The grabber includes a first arm that has non-uniform physical properties that vary along its length such that the first arm has a stiffness that varies along its length. A first section of the first arm has a lower stiffness than other sections of the first arm. The second arm faces and cooperates with the first arm to clamp and engage the refuse container.

In some implementations, the first arm is made of a composite, anisotropic material including fibers and an epoxy. The fibers are arranged in different directions such that the stiffness of the first arm is non-uniform along its length.

In some implementations, the first arm includes a first non-metallic arm, and the first section is a middle section of the first non-metallic arm.

In some implementations, the first non-metallic arm flexes along the middle section in response to a clamping force applied to the first non-metallic arm by the grabber when engaging the refuse container.

In some implementations, the second arm includes a second section having a first stiffness, and a third section having a second stiffness less than the first stiffness to allow the second arm to flex when engaging the refuse container.

In some implementations, the first section is a middle section that resides between a second section of the first arm proximate the vehicle and third section of the first arm distal from the vehicle. The middle section has a stiffness that is less than the second section and the third section.

In some implementations, the middle section has fibers arranged offset with respect to a tensile load direction of the middle section during engagement of the refuse container.

In some implementations, the first arm is a one-piece arm including an inner profile shaped to substantially correspond with an outer shape of the refuse container.

In some implementations, the inner profile includes a first section extending from the lift arm, a middle section extending from the first section, and a distal section extending from the middle section opposite the first section. A longitudinal axis of the middle section extends at an angle of between 0 and 90 degrees with respect to a longitudinal axis of the first section, and at an angle of between 0 and 90 degrees with respect to a longitudinal axis of the distal section.

In some implementations, the refuse collection vehicle further includes a hopper mounted on the wheeled chassis and configured to receive refuse from the refuse container.

In some implementations, the first section has a stiffness that is about 0 to 90% less than a stiffness of the other sections.

In some implementations, the first section includes carbon fibers oriented along a length direction of the first section.

In some implementations, the first arm has a thickness that decreases along a length of the arm.

In some implementations, each of the first arm and the second arm each include an inner surface and a compliant gripper pad attached to the inner surface. The compliant grip pad contacts and grips the refuse container.

In some implementations, the lift arm includes a pair of rotatable shafts each coupled to a respective one of the first arm and second arm, each rotatable shaft configured to rotate to move the first arm and second arm between an open position, in which the refuse container is disengaged, and a closed position in which the refuse container is engaged by the first arm and second arm.

Implementations of the present disclosure include an apparatus, including a first grabber arm and a second grabber arm. The first grabber arm is coupled to a lift arm of a refuse collection vehicle to engage a refuse container. The first grabber arm has non-uniform physical properties that vary along its length such that the first grabber arm has a stiffness that varies along its length, a first section of the first grabber arm having a lower stiffness than other sections of the first arm. The second grabber arm cooperates with the first grabber arm to clamp and engage the refuse container.

In some implementations, the first grabber arm is a first non-metallic grabber arm and the second grabber arm is a second non-metallic grabber arm.

In some implementations, each of the first grabber arm and the second grabber arm includes a one-piece arm that includes multiple sections, each section having a different stiffness.

In some implementations, each of the first grabber arm and the second grabber arm is made of a fiber-reinforced composite. In some implementations, each of the first grabber arm and the second grabber arm is made of thermoset polymer and carbon fiber.

In some implementations, each of the first grabber arm and the second grabber arm includes an inner surface and a compliant gripper pad attached to the inner surface. The compliant grip pad contacts and grips the refuse container.

In some implementations, each of the first grabber arm and the second grabber arm attaches to a respective connection arm fixed to a respective rotatable shaft of the lift arm. Each rotatable shaft rotates to move a respective one of the first grabber arm and the second grabber arm between an open position, in which the refuse container is disengaged, and a closed position in which the refuse container is engaged by the first grabber arm and the second grabber arm.

In some implementations, the first grabber arm is a one-piece arm including a plurality of sections. Each section of the plurality of sections has a different stiffness.

In some implementations, an inner profile of the first grabber arm is arranged to substantially correspond with an outer shape of the refuse container.

In some implementations, the first section includes a middle section and the first grabber arm further includes a proximal section and an distal section, with the middle section including a stiffness less than a stiffness of the proximal section and the distal section. In some implementations, the middle section includes a stiffness that is between 1% and 90% less than a stiffness of the proximal section. In some implementations, the middle section extends at an angle of between 0 degrees and 90 degrees with respect to the first section and the distal section.

In some implementations, the second grabber arm is a metallic grabber arm.

In some implementations, the second grabber arm is formed of spring steel.

In some implementations, the first grabber arm is anisotropic and non-homogeneous, the first section is a middle section of the first grabber arm, and the middle section is disposed between a proximal section and a distal section of the first grabber arm.

In some implementations, the middle section has fibers arranged offset with respect to a tensile load direction of the middle section during engagement of the refuse container.

In some implementations, the first grabber arm is made of a fiber-reinforced composite including multiple plies. At least one of the multiple plies include fibers made of a material different than another one of the multiple plies.

Particular implementations of the subject matter described in this specification can be implemented so as to realize one or more of the following advantages. For example, grabber arms described herein can have design features that are more difficult, costly, or impossible to achieve using traditional materials (e.g., spring steel). For example, grabber arms described herein can have compound curves, varying thicknesses, and varying stiffness along sections of similar or equal dimensions. Such features can allow the grabber arms described herein to firmly hold the refuse container without damaging the refuse container, which can be hard to accomplish with traditional spring steel grabbers. Moreover, the grabber arms described herein can be container specific, with a shape or cross-section designed to grab different refuse containers. Additionally, the grabber arms described herein can be lighter, more flexible, and more reliable than other types of grabber arms. Lighter grabber arms can help reduce stress on the lift arm and increase the efficiency of the refuse collection vehicle.

### BRIEF DESCRIPTION OF THE DRAWINGS

FIG. 1 is a perspective, schematic view of an example refuse collection vehicle.

FIG. 2 is a top, schematic view of the grabber of FIG. 1.

FIG. 3 is a perspective, schematic view of a grabber arm of the grabber of FIG. 1.

FIG. 4 is a perspective, schematic view of a section of a grabber arm according to a different implementation of the present disclosure.

FIG. 5 is a perspective, schematic view of a section of another example refuse collection vehicle.

### DETAILED DESCRIPTION OF THE DISCLOSURE

The present disclosure describes embodiments featuring a grabber that allows a refuse collection vehicle to collect refuse more effectively and efficiently from refuse containers. In some embodiments, the grabber includes two grabber arms (“arms”) that cooperatively engage a refuse container. In some embodiments, each grabber arm has multiple sections along its length, each section having a different stiffness. This non-uniform stiffness profile along the length of the grabber arm enables the arm to selectively deform in response to the application of force against the arm when contacting a refuse container. As a result, the arms wrap around and grab the container in a manner that is more firm and secure than conventional spring-steel grabber arms.

Each arm can be made of composite or only some parts of the arm can be made of composite. In some aspects, the term “composite” refers to a material made of two materials with different chemical and physical properties. For example, each arm can be made of a fiber-reinforced, polymeric, composite material, such as a carbon-reinforced epoxy material, a non-epoxy resin system, an aramid fiber, a fiberglass-reinforced epoxy material, or a thermo-plastic resin system. In some aspects, the two main components within a composite used to form all or a portion of the arm are a matrix and a reinforcement fiber. The matrix is the base material and is reinforced by the fibers, which are disposed in the matrix. Composites can also include core materials, fillers, additives, and surface finishes to provide unique performance attributes. The composite materials referred to herein include fiber-reinforced polymer composites.

The fibers used to form the composite of the grabber arm can include one or more of glass, carbon, graphite, basalt, natural fibers, an aromatic polyamide (i.e., “aramid”) material, a variant of an aromatic polyamide material (e.g., a polyparaphenylene terephthalamide material), or the like. These fibers reinforce the material and provide strength and stiffness to the composite. The matrix (e.g., polymeric matrix) can include materials such as polyester, epoxy, vinyl ester, cyanide ester, and polyurethane, polyamide, bismaleimide, phenolic, polyetheretherketone (PEEK), polyetherketone (PEK), polyphenylene sulfide (PPS), and the like. The matrix acts as a glue to hold the fibers of the composite together and protect the fiber from damage. Example composite materials are described in U.S. Pat. Nos. 9,302,869, 9,821,520, and 10,800,112.

Each arm is formed using any suitable process, including, but not limited to, tape-placement, fiber-placement, filament-winding, resin infusion (such as braiding and resin transfer molding (RTM) or vacuum assisted resin transfer method (VARTM)) autoclaving, or hand layup. The resins can be applied to the dry fibers in a “pre-preg” format or introduced in-situ as a wet-layup.

While traditional spring steel grabber arms have a generally uniform stiffness, composite grabber arms can be engineered to be more flexible at key points of the arms while maintaining their strength to securely grab and lift refuse containers. Specifically, compared to spring steel, the composite material can be engineered to have a non-uniform stiffness and non-uniform physical properties (e.g., to be anisotropic, be lighter, resist bigger loads, and/or be more flexible).

As referred to herein, “stiffness” is the extent to which an object resists deformation in response to an applied force. For example, the stiffness of a grabber arm is the extent to which the grabber arm resists deformation when a force is applied to the grabber arm, such as the force applied to the grabber arm when the grabber engages a refuse container. The stiffer a section of the grabber arm is, the less that section deforms in response to an applied force. If one section of the grabber arm is stiffer than another, the stiffer section has a higher elastic modulus, allowing it to better maintain its shape under stress, while the other section with a lower elastic modulus is more flexible.

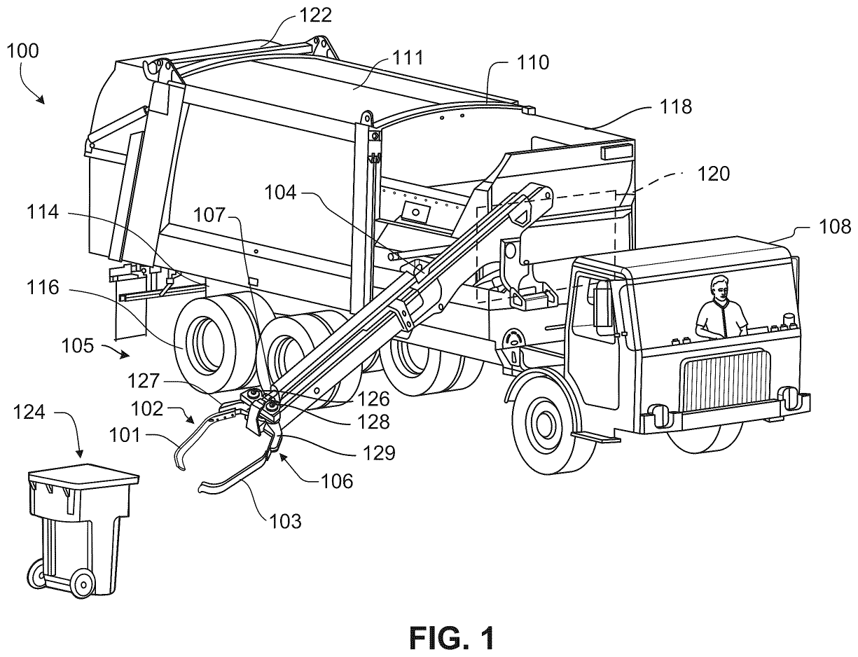

Each grabber arm described herein in reference to FIGS. 1-5 can be made of a composite material that is anisotropic and non-homogeneous. The composite arm can be designed to have a different strength and stiffness in different directions through the material and is stronger along its fibers than across them. Specifically, the composite(s) used to form the grabber arms depicted in FIGS. 1-4 can resist higher loads under tension or compression along the length of its fibers than loads in a direction perpendicular to its fibers. Additionally, as opposed to metals, which are homogeneous (e.g., with uniform physical properties such as uniform density), the composite arm described herein can have non-uniform physical properties. For example, the density or clastic properties at one location of the arm can be different from another location.

Each grabber arm described herein in reference to FIGS. 1-4 has non-uniform physical properties that cause the grabber to have a stiffness that varies along the length of the respective grabber arm. The stiffness and strength along any axis of the grabber arms described herein in reference to FIGS. 1-4 depends on the mechanical properties or ratios of the fiber and resin and on fiber placement and orientation. In a carbon fiber component, the strength resides along the axis of the fibers, and thus fiber density and orientation greatly impact mechanical properties of the composite material. This allows the mechanical properties of the part (e.g., a grabber arm) to be tailored along any axis. When fibers in the composite forming the composite arms are oriented in the direction of the load, the composite arms can be stronger and stiffer under such a load compared to an arm in which the fibers are oriented at an angle with respect to the load. Specifically, when the load applied puts the fibers under axial tension, the arm can resist more load than if the fibers were under axial compression or transverse compression. For example, the carbon fibers' axial compressive strength is 10%-60% of their tensile strength and their transverse compressive strength is 12%-20% of their axial compressive strength.

In some aspects, the fibers are oriented in one or more directions of the composite forming the grabber arm to provide particular stiffnesses along the length of the grabber arm. In addition, the fibers of the composite forming the grabber arm can be woven or unwoven, which can affect the stiffness of the composite. Also, each composite arm can include fibers arranged in multiple directions or in a single direction, such as a uniaxial or helical fiber configuration.

The properties of the composite arms are controlled at least by the choice of fiber, resin, dimensions of the arms, and orientation or layup of the fibers. Specifically, the type of fibers, resin, and orientation of the fibers can be selected to have various clastic moduli and stiffness along the length of the grabber arms. Thus, the fibers can be arranged to best utilize their directional strength according to the load direction of each grabber arm. For example, to design a grabber arm that widens and expands (e.g., stretches to increase the radius of the curved profile of the grabber) when engaging a refuse container, the fibers in the middle can be arranged normal (e.g., along the width of the grabber) with respect to the tensile forces applied to the middle section of the grabber, allowing the grabber to flex at the middle. If the ends of the grabber arm are to be stiffer than the middle, the fibers can be arranged parallel (e.g., along the length of the grabber) with respect to the tensile force, preventing the ends of the grabber from substantially flexing or stretching. The grabber arms described herein in reference to FIGS. 1-4 can be a one-piece component with the fibers laid in different directions during the manufacturing process of the grabber.

FIG. 1 shows an example refuse collection vehicle 100, which is an automated side loader (ASL). While side loaders are illustrative, a front loader and any other type of vehicle, device, or system that employs a grabber to engage a refuse container can be implemented in accordance with this disclosure. For example, the grabber arms described in the embodiments of this disclosure can be implemented with the robotic side-loading lift on the intermediate container of a front loader.

Refuse collection vehicle 100 has a wheeled chassis 105. Wheeled chassis 105 includes a lower frame 114 and road wheels 116 attached to lower frame 114. Refuse collection vehicle 100 also includes a cabin 108 (e.g., a driver's cab) and a refuse collection body 110 carried by wheeled chassis 105. Refuse collection body 110 defines a refuse storage compartment or tank 111 that stores the waste material collected by refuse collection vehicle 100. Refuse collection body 110 also includes a hopper 118 and a packer 120 that packs or compresses the refuse in hopper 118 and pushes the refuse into storage compartment 111.

In some aspects, refuse collection vehicle 100 also includes other body components such as a pump (not shown), a tailgate 122, linear actuators, and so forth. The body components may also include other types of components that operate to bring garbage into the hopper (or other storage area) of a truck, compress and/or arrange the garbage in the vehicle, and/or expel the garbage from the vehicle.

Refuse collection vehicle 100 also includes a lift arm 104, a grabber or grabber assembly 102, and an interface assembly 106. Grabber 102 includes two non-metallic grabber arms 101, 103 (also referred to herein as arms 101, 103) that grab a refuse container 124. Refuse collection body 110 can be operated by hydraulic actuators or electric actuators. For example, refuse collection vehicle 100 can be an electric vehicle in which body 110 includes electric actuators that move lift arm 104 and grabber 102, and can include other electrical components (not shown) such as a battery pack, a charger, an inverter, sensors, switches, and control systems.

As shown in FIG. 1, lift arm 104 and grabber 102 are operable to grab, lift, and empty refuse container 124 into hopper 118, and then place refuse container 124 back on the ground. Specifically, grabber arms 101, 103 of grabber 102 cooperate with each other to clamp and engage refuse container 124.

In some aspects, grabber 102 is coupled to a distal end 107 of lift arm 104 by an interface assembly 106. Interface assembly 106 has rotatable shafts 126, 128 and connection arms 127, 129. Each connection arm 127, 129 is fixed to a respective one of rotatable shafts 126, 128. Each rotatable shaft 126, 128 rotates to move its respective connection arm 127, 129 and by extension rotates the respective grabber arm 101, 103. Thus, rotation of shafts 126, 128 move grabber arms 101, 103 between an open position, in which refuse container 124 is disengaged, and a closed position, in which refuse container 124 is engaged by grabber 102.

Each arm 101, 103 of grabber 102 is made of a non-metallic material such as a fiber-reinforced composite. For example, each arm 101, 103 can be made of carbon fiber, aramid fiber, fiberglass, or a similar material or combination thereof, and a polymer material. In some implementations, grabber arms 101, 103 include a thermoset polymer. In some implementations, grabber arms 101, 103 include a thermoplastic polymer. Such composite materials allow each arm 101, 103 to flex when engaging refuse container 124. For example, as each arm 101, 103 engages a respective side of refuse container 124, each arm 101, 103 flexes to accommodate the outer shape of refuse container 124 and thereby firmly grasps refuse container 124 without substantially deforming refuse container 124.

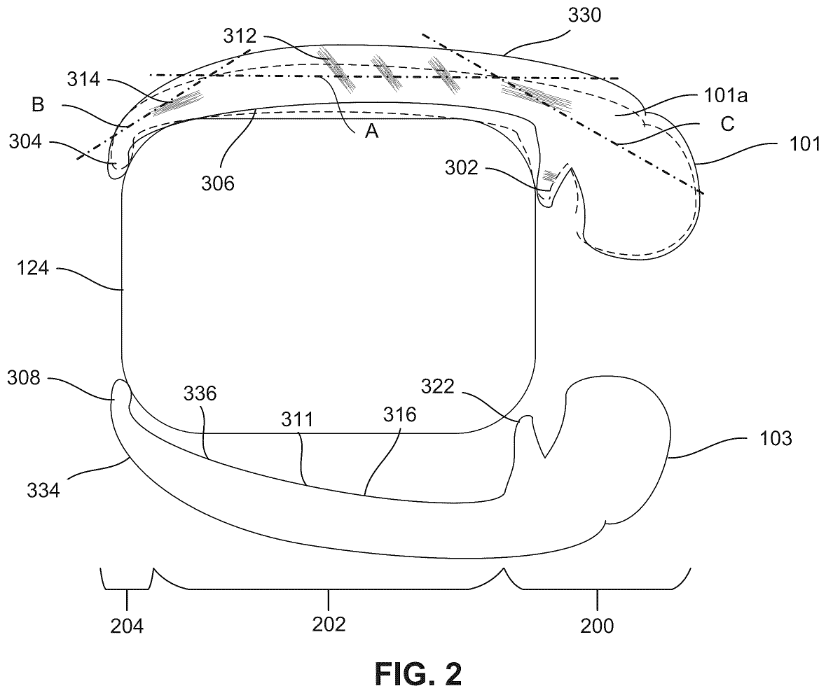

FIG. 2 shows a top view of grabber arms 101, 103 engaging refuse container 124. Each grabber arm 101, 103 has a proximal section 200 (e.g., near the vehicle), a middle section 202, and a distal section 204. Proximal section 200 is secured to the interface assembly 106 of lift arm 104 (shown in FIG. 1). In some aspects, the proximal section 200 is the section of the grabber arm 101 that interfaces with and is attached (e.g., secured with mechanical fasteners) to the interface assembly 106 of the lift arm 104. The proximal section 200 of each grabber arm 101, 103 has a proximal finger 302, 322 that can be pushed against refuse container 124. The distal section 204 of each grabber arm 101, 103 has distal finger 304, 308 that can be pushed against refuse container 124 toward the respective proximal finger 302, 322 to clamp refuse container 124. The middle section 202 of each grabber arm 101, 103 extends between the proximal section 200 to the distal section.

In some aspects, each of sections 200, 202, 204 of each grabber arm 101, 103 has a different stiffness. For example, in some implementations, all or some of middle section 202 of each grabber arm 101, 103 has a stiffness that is less than a stiffness of the first section 202 and the distal section 204 of each grabber arm 101, 103. In some cases, middle section 202 of each grabber arm 101, 103 has a stiffness that is, for example, between 1% and 90% less than the stiffness of the proximal section 200 and/or the distal section 204 of the respective grabber arm 101, 103. In some aspects, the proximal section 200 of each grabber arm 101, 103 is the stiffest section of the respective grabber arm 101, 103 in order to provide strength at the connection point of grabber arm 101, 103 to the lift arm 104 of the vehicle 100. In some aspects, the middle section 202 of each grabber arm 101, 103 has the lowest stiffness to allow the arm 101, 103 to flex around refuse container 124 and firmly grip container 124 without damaging container 124. In some aspects, the distal section 204 of each grabber arm 101, 103 is less stiff than proximal section 200 of the respective grabber arm 101, 103 to allow for better grip around refuse container 124 compared to metal grabbers.

With the middle section 202 of each grabber arm 101, 103 being the least stiff of sections 200, 202, 204, each arm 101, 103 can elastically deform or flex along the middle second section 202 in response to a clamping force applied to first arm 101 and second arm 103 when the grabber 102 is engaging a refuse container 124. The clastic deformation of the arms 101, 103 allows the arms 101, 103 to change to a second shape or position 101a and conform to the outer surface of the refuse container 124 engaged by the grabber 102. In some aspects, arms 101, 103 deform into position 101a in which an inner surface of middle section 202 is closer to (or contacts) the outer surface of refuse container 124. In other words, the stiffness of each arm 101, 103 is designed so that the refuse container 124 deforms each grabber arm 101, 103 as each arm closes around the refuse container 124, causing the grabber arms 101, 103 to bend outwards. Thus, each arm 101, 103 flexes to allow the respective arm 101, 103 to more fully contact the refuse container 124 and firmly engage the refuse container 124 without deforming or otherwise damaging the refuse container 124.

In some aspects, sections 200, 202, 204 of each grabber arm 101, 103 are made of fiber-reinforced composite, with at least some of the sections 200, 202, 204 having a different fiber orientation than the other sections. For example, to form a middle section 202 with a stiffness that is less than the stiffness of the rest of the arm, the middle section 202 of each grabber arm 101, 103 can have a fiber arrangement that is at an angle with respect to the loading direction of middle section 202. In some aspects, the fibers 314 of the arm are oriented longitudinally, parallel to the length (e.g., parallel to the longitudinal axes “B” and “C”) of the section of the arm, except for the fibers 312 in the middle section 202 of the arm (or in any given area where less stiffness is desired). To decrease the stiffness the middle section 202, the fibers 312 in the middle section are laid at an angle relative to the longitudinal axis “A” or length of the middle section 202. The greater the angle of the fibers relative to the longitudinal axis of the respective section of the grabber arm 101, 104, the less stiff the respective arm is in that section. For example, as shown in FIG. 2, if using woven fibers in the composite (e.g., woven fibers 90 degrees offset from each other), the orientation of the fibers 312 can be varied from around 0.1 to 45 degrees with respect to the longitudinal axis to reduce the bending stiffness of the middle section 202.

In some aspects, proximal and distal sections 200, 204 of each grabber arm 101, 103 have a fiber arrangement aligned with the loading direction of the respective arm. As a result, as the grabber arm 101, 103 widens (e.g., opens out) when engaging the refuse container 124, such that the middle section 202 bends and moves closer to the outer surface of the refuse container 124

As discussed herein, the proximal section 200 and distal section 204 of the grabber arms 101, 103 are each stiffer than the middle section 202 of the respective arm 101, 103. In order to provide this increased stiffness, the fibers 314 at the proximal section 200 and distal section 204 of the grabber arms 101, 103 are arranged parallel with respect to the tensile force applied to the ends of the grabber arms 101, 103 (e.g., along the length of the grabber arms 101, 103), preventing the ends of the grabber arms 101, 103 from substantially flexing or stretching when engaging a refuse container 124. The increased stiffness of the proximal section 200 and distal section 204 allows for a secure grasp of the corners of a refuse container 124 engaged by the grabber 102, and the more flexible middle section 202 allows the arms to bend, increasing the spring effect (and thus the grabbing force) of the arms 101, 103, and allowing the arms to conform to the shape of the refuse container 124. Each arm can be a one-piece component, with the fibers laid in different directions during the manufacturing process of the arm.

In some aspects, each arm 101, 103 is formed as a one-piece body with an inner profile 306, 316 shaped to generally correspond with an outer shape of refuse container 124. For example, each arm 101, 103 has a first finger 302, 322 and second finger 304, 308 opposite first finger 302. Each of fingers 302, 304, 308, 322 wrap around refuse container 124 or prevents the refuse container from slipping out of the grabber. In some aspects, the thickness of each arm 301, 303 varies along the length, with the tip finger 304 of the respective arm 101, 103 being the thinnest section. The thickness of each arm 101, 103 can vary, for example, between 0.1 and 10 inches.

In some aspects, the thickness of a composite is controlled by controlling the number of layers (e.g., plies) used to form the composite material. The more plies the arm has, the greater its thickness. The stiffness in a given portion of a composite element can be changed by reducing the number of plies in the respective portion of the composite element (e.g., by tapering the number of layers in a given area). In some implementations, a composite grabber with a thickness of 0.25 inches can have the same or similar strength of a steel grabber with a thickness of 0.5 inches.

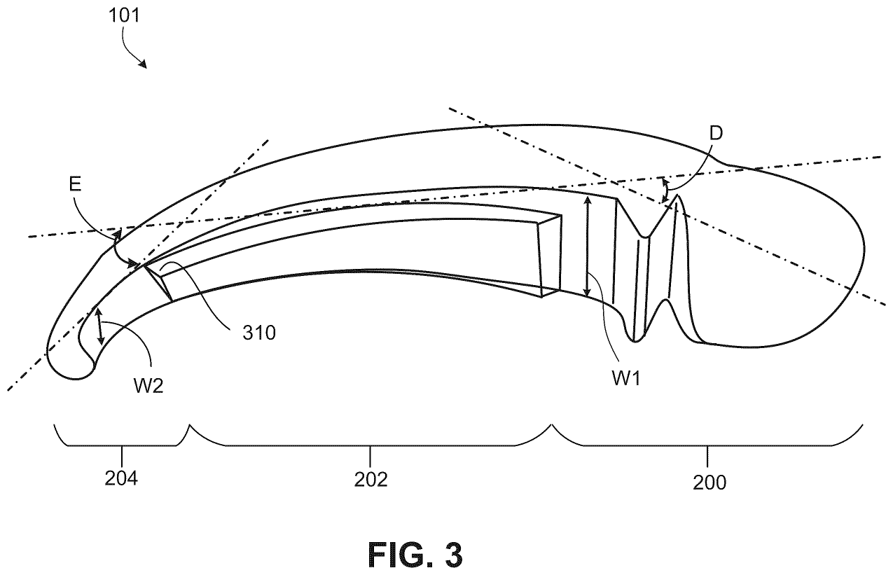

In some aspects, proximal section 200 of each arm 101, 103 has a length of, for example, between 5 and 20 inches, middle section 202 has a length of, for example, between 1 and 20 inches, and distal section 204 has a length of, for example, between 1 and 20 inches. Referring also to FIG. 3, middle section 202 of each grabber arm 101, 103 can extend at an angle “D” with respect to the proximal section 200, and extends at an angle “E” with respect to distal section 204. The angles and length of each section 200, 202, 204 allow the arms 101, 103 to embrace the refuse container 124 as the grabber arms 101, 103 clamp the refuse container 124. Angle “D” can be, for example, between 0 degrees and 90 degrees and angle “E” can be, for example, between 0 degrees and 90 degrees. Also, the grabber arms 101, 103 can have a tapered profile in which proximal section 200 has a first width “W1” and distal section has a second width “W2” less than the proximal section 200 so that the distal tip of the arms 101, 103 are thinner or more narrow than the proximal section 200 of the arms 101, 103.

Each grabber arm 101, 103 each include a compliant gripper pad 310, 311 attached to the inner surface of the respective grabber arm 101, 103. The compliant gripper pad 310, 311 can be a rubber pad or another type of elastomeric pad that contacts the refuse container to grip and engage the refuse container.

Referring back to FIG. 2, the shape of one or both of the grabber arms 101, 103 can be such that, when the grabber arms 101, 103 engage the container 124, the grabber arms 101, 103 deflect away from the container 124 upon contact with the container 124. Specifically, the second grabber arm 103 depicted in FIG. 2 has a shape that allows the distal end 308 of the second grabber arm 103 to engage the refuse container 124 before the rest of the second grabber arm 103, including its proximal finger 322, contacts the container 124. In particular, the radius of curvature of the second grabber arm 103 is less than the radius of curvature of the container 124, which results in the distal section 204 of the grabber arm 103 engaging the container 124 before the proximal section 200 engages the container 123. As a result, grabbing action of the grabber arms 101, 103 is prevented from pushing the container 124 away from the refuse vehicle 100.

In some implementations, the distal sections 204 of the grabber arms 101, 103 are less stiff than the proximal sections 200. As a result, the distal sections 204 deflect more than the proximal sections 200 when the grabber arms 101, 103 engage the container 124 and the pressure applied on the container 124 by the distal sections 204 is lower than the pressure applied on the container 124 by the proximal sections 200. The stiffness in each section can be varied to minimize the possibility of crushing the container 124.

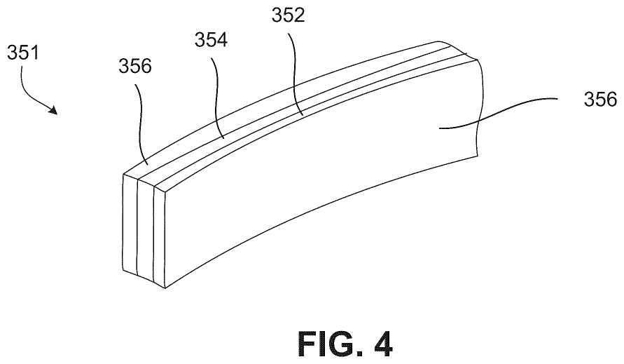

FIG. 4 shows a distal section of a grabber arm 351 according to an example implementation of the present disclosure. The grabber arm 351 is made of multiple plies 352, 354, 356. Some or all of the plies can be made of different fiber materials. For example, a first ply 352 can be made with glass fibers, a second ply 354 can be made with carbon fibers, and a third ply 356 can be made with carbon fibers or a different type of fibers, such as aramid fibers. The resin used to form each ply can be the same. Example resins for forming the plies 352, 354, 356 of the grabber arm 351 include, but are not limited to, a pre-impregnated resin, epoxy resin, or an ester resin. In some aspects, the grabber arm 351 has glass fiber plies in between carbon fiber and aluminum fiber plies to act as a galvanic barrier between carbon and aluminum.

In some implementations, the first ply 352 serves as a “facing ply” of fiberglass to act as a sacrificial or wear layer to protect the inner fibers. For example, the first ply 352 has a grabbing surface 356 that directly contacts the refuse container to grab the refuse container. In such cases, the inner plies 354, 356 can make up the entire strength of the grabber arm so that the wearing of the first ply 352 does not diminish the strength of the grabber arm 351.

Thus, the pressure applied by the grabber arms 101, 103 and by different sections of the grabber arms 101, 103 can vary based on the shape and the stiffness of the grabber arms 101, 103 at any given point along their length.

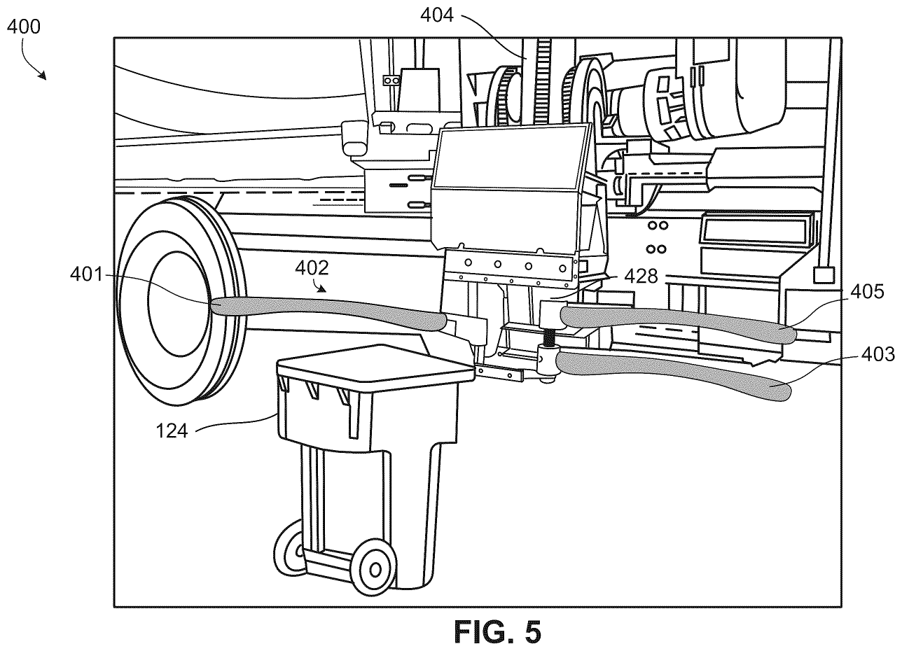

FIG. 5 shows refuse vehicle 400 with a different configuration of a lift arm 404 and a grabber 402. Grabber 402 has three grabber arms 401, 403, 405, including a left arm 401 that is offset with respect to two right arms 403, 405. The grabber arms 401, 403, 405 are substantially similar in construction and function to grabber arms 101, 103 described in reference to FIGS. 1-3.

Left arm 401 cooperates with both right arms 403, 405 to clamp and engage refuse container 124. For example, to engage refuse container 124, lift arm 404 extends outwardly to position grabber 402 near refuse container 124. Once grabber 402 is near refuse container 124, shafts 428 rotate to close grabber arms 401, 403, 405 and engage refuse container 124. Once refuse container 124 is engaged, lift arm 404 lifts grabber 402 to lift and dump refuse container 124 on the hopper of refuse vehicle 400.

In some aspects, grabber arms 401, 403, 405 are made of a non-metallic material such as a fiber-reinforced composite. Such composite materials allow each arm 401, 403, 405 to flex when engaging refuse container 124. For example, as each arm 401, 403, 405 engages a side of refuse container 124, each arm 401, 403, 405 flexes to accommodate the outer shape of refuse container 124 and thereby firmly grasps refuse container 124 without substantially deforming refuse container 124.

While certain embodiments have been described, other embodiments are possible. For example, while sections 200, 202, 204 of grabber arms 101, 103 in FIG. 2 have been described as each having a different stiffness, in some embodiments, two or more of sections 200, 202, 204 of grabber arms 101, 103 have the same stiffness. Also, other components of arms 101, 103 such as corners and surfaces can have a different stiffness. Moreover, while grabber 402 in FIG. 5 has been shown with three arms 401, 403, 405, grabber 402 can have two, four, or more arms. Also, while grabber arms 101, 103 have been shown with different thicknesses and widths, grabber arms 101, 103 can have a constant or generally constant width and/or thickness. Additionally, while all grabber arms 101, 103, 410, 403, 405 have been described as being made of composite material, one or more arms can be made of spring steel to interact with the composite arm(s) to grab refuse container 124.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations.

Several implementations have been described. Nevertheless, it will be understood that various modifications may be made without departing from the spirit and scope of the disclosure. For example, example operations, methods, or processes described herein may include more steps or fewer steps than those described. Further, the steps in such example operations, methods, or processes may be performed in different successions than that described or illustrated in the figures. Accordingly, other implementations are within the scope of the following claims.

What is claimed is:

1. A refuse collection vehicle, comprising:
a wheeled chassis;
a lift arm coupled to the wheeled chassis and operable to lift a refuse container; and
a grabber coupled to a distal end of the lift arm and operable to grab the refuse container, the grabber comprising:
a first arm having non-uniform physical properties that vary along its length such that the first arm has a stiffness that varies along its length, a first section of the first arm having a lower stiffness than other sections of the first arm; and
a second arm configured to cooperate with the first arm to clamp and engage the refuse container.

2. The refuse collection vehicle of claim 1, wherein the first arm is made of a composite, anisotropic material comprising fibers and an epoxy, the fibers arranged in different directions such that the stiffness of the first arm is non-uniform along its length.

3. The refuse collection vehicle of claim 1, wherein the first arm comprises a first non-metallic arm, and the first section is a middle section of the first non-metallic arm.

4. The refuse collection vehicle of claim 3, wherein the first non-metallic arm flexes along the middle section in response to a clamping force applied to the first non-metallic arm by the grabber when engaging the refuse container.

5. The refuse collection vehicle of claim 1, wherein the second arm comprises:
a second section having a first stiffness; and
a third section having a second stiffness less than the first stiffness to allow the second arm to flex when engaging the refuse container.

6. The refuse collection vehicle of claim 1, wherein the first section is a middle section that resides between a second section of the first arm proximate the vehicle and third section of the first arm distal from the vehicle, the second and third sections comprising fibers arranged along a longitudinal axis of each respective section, and the middle section comprising fibers arranged at an angle with respect to a longitudinal axis of the middle section, thereby having a stiffness that is less than the second section and the third section.

7. The refuse collection vehicle of claim 6, wherein the middle section has fibers arranged offset with respect to a tensile load direction of the middle section during engagement of the refuse container.

8. The refuse collection vehicle of claim 1, wherein the first arm is a one-piece arm comprising an inner profile, and the inner profile comprises:
a first section extending from the lift arm;
a middle section extending from the first section; and
a distal section extending from the middle section opposite the first section,
wherein the middle section extends at an angle with respect to the first section, and the middle section extends at an angle with respect to the distal section.

9. The refuse collection vehicle of claim 1, wherein the first section has a stiffness that is about 0 to 90% less than a stiffness of the other sections.

10. The refuse collection vehicle of claim 1, wherein the first section comprises carbon fibers oriented along a length direction of the first section.

11. The refuse collection vehicle of claim 1, wherein the grabber comprises a third arm attached to a same side of the grabber as the second arm, the first arm configured to cooperate with the second arm and the third arm to clamp and engage the refuse container.

12. The refuse collection vehicle of claim 11, wherein the first arm is arranged offset with respect to the second arm and the third arm.

13. An apparatus, comprising:
a first grabber arm configured to be coupled to a lift arm of a refuse collection vehicle to engage a refuse container, the first grabber arm having non-uniform physical properties that vary along its length such that the first grabber arm has a stiffness that varies along its length, a first section of the first grabber arm having a lower stiffness than other sections of the first arm; and
a second grabber arm configured to cooperate with the first grabber arm to clamp and engage the refuse container.

14. The apparatus of claim 13, wherein the first grabber arm is a first non-metallic grabber arm, and the second grabber arm is a second non-metallic grabber arm.

15. The apparatus of claim 13, wherein each of the first grabber arm and the second grabber arm comprises a one-piece arm comprising a plurality of sections, at least one of the plurality of sections having a stiffness different than another one of the plurality of sections.

16. The apparatus of claim 13, wherein each of the first grabber arm and the second grabber arm is made of a fiber-reinforced composite.

17. The apparatus of claim 13, wherein each of the first grabber arm and the second grabber arm is configured to be attached to a respective connection arm fixed to a respective rotatable shaft of the lift arm, each rotatable shaft configured to rotate to move a respective one of the first grabber arm and the second grabber arm between an open position, in which the refuse container is disengaged, and a closed position in which the refuse container is engaged by the first grabber arm and the second grabber arm.

18. The apparatus of claim 13, wherein the first grabber arm is a one-piece arm comprising a plurality of sections, each section of the plurality of sections having a different stiffness.

19. The apparatus of claim 13, wherein the first section comprises a middle section and the first grabber arm further comprises a proximal section and an distal section, with the middle section comprising a stiffness less than a stiffness of the proximal section and the distal section.

20. The apparatus of claim 13, wherein the first grabber arm is made of a fiber-reinforced composite comprising a plurality of plies, at least one of the plurality of plies comprising fibers made of a material different than another one of the plurality of plies.
